(19) United States
(12) Patent Application Publication
(10) Pub. No.: US 2025/0294232 A1
(43) Pub. Date: Sep. 18, 2025

(54) IMAGE ACQUISITION DEVICE

(71) Applicant: Japan Display Inc., Tokyo (JP)

(72) Inventors: Tomoya TEZEN, Tokyo (JP); Daisuke HAMANO, Tokyo (JP); Daichi ABE, Tokyo (JP)

(21) Appl. No.: 19/077,304

(22) Filed: Mar. 12, 2025

(30) Foreign Application Priority Data
Mar. 14, 2024 (JP) 2024-040073

(51) Int. Cl. H04N 23/57; G01N 21/01; G01N 21/03; H04N 23/51; H04N 23/55; H04N 23/56

(52) U.S. Cl. CPC H04N 23/57; G01N 21/0303; H04N 23/51; H04N 23/55; H04N 23/56; G01N 2021/0106

(57) ABSTRACT

According to an aspect, an image acquisition device includes, in sequence: a light source; a holding member configured to hold a container accommodating an object to be detected; a view angle control film; and a planar optical sensor. The image acquisition device further includes: a light-transmitting adhesive layer between the view angle control film and the optical sensor and configured to bond the view angle control film to the optical sensor; and an elastic member configured to push up and urge the holding member upward to press the container against the view angle control film.

### CROSS-REFERENCE TO RELATED APPLICATION

This application claims the benefit of priority from Japanese Patent Application No. 2024-040073 filed on Mar. 14, 2024, the entire contents of which are incorporated herein by reference.

### BACKGROUND

### 1. Technical Field

What is disclosed herein relates to an image acquisition device.

### 2. Description of the Related Art

Japanese Patent Application Laid-open Publication No. 2018-033430 discloses an image acquisition device that includes an optical sensor (photosensor), a container to contain objects to be detected (microorganisms) and a culture medium, and a light source, and acquires images indicating a growth over time of the microorganisms in the container. Specifically, the container is placed above the optical sensor (photosensor) and the light source is positioned above the container. Light emitted from the light source passes through the objects to be detected and the culture medium in the container, and reaches the optical sensor. The optical sensor can image the objects to be detected because the quantity of light emitted to photodiodes of the optical sensor differs between an area overlapping the objects to be detected and an area not overlapping the objects to be detected.

Image acquisition devices that can achieve higher detection accuracy are required.

### SUMMARY

According to an aspect, an image acquisition device includes, in sequence: a light source; a holding member configured to hold a container accommodating an object to be detected; a view angle control film; and a planar optical sensor. The image acquisition device further includes: a light-transmitting adhesive layer between the view angle control film and the optical sensor and configured to bond the view angle control film to the optical sensor; and an elastic member configured to push up and urge the holding member upward to press the container against the view angle control film.

### BRIEF DESCRIPTION OF THE DRAWINGS

FIG. 1 is a sectional view schematically illustrating an image acquisition device according to an embodiment of the present disclosure;

FIG. 2 is an enlarged schematic view of a part of FIG. 1;

FIG. 3 is an enlarged perspective view of a container in FIG. 1;

FIG. 4 is a block diagram illustrating a configuration example of the image acquisition device according to the embodiment;

FIG. 5 is a sectional view schematically illustrating a collimator layer according to the embodiment;

FIG. 6 is a sectional view schematically illustrating a louver layer according to the embodiment;

FIG. 7A is a schematic view illustrating a state of mounting of a view angle control film and an optical sensor in a housing according to a first comparative example;

FIG. 7B is a schematic view illustrating a state of mounting of the view angle control film and the optical sensor in a housing according to a second comparative example;

FIG. 8 is a schematic view of an image acquisition device according to a comparative example;

FIG. 9 is a photographic image of a culture medium captured by the image acquisition device of the embodiment; and

FIG. 10 illustrates photographic images of the culture medium captured by the image acquisition device of the second comparative example illustrated in FIG. 7B.

### DETAILED DESCRIPTION

The following describes a mode (embodiment) for carrying out the present disclosure in detail with reference to the drawings. The present disclosure is not limited to the description of the embodiment given below. Components described below include those that are easily conceivable by those skilled in the art or those that are substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present disclosure and the drawings, and detailed description thereof may not be repeated where appropriate. In the drawings, “UP” indicates the upper side; “LW” indicates the lower side; “RH” indicates the right side, and “LH” indicates the left side.

### Embodiment

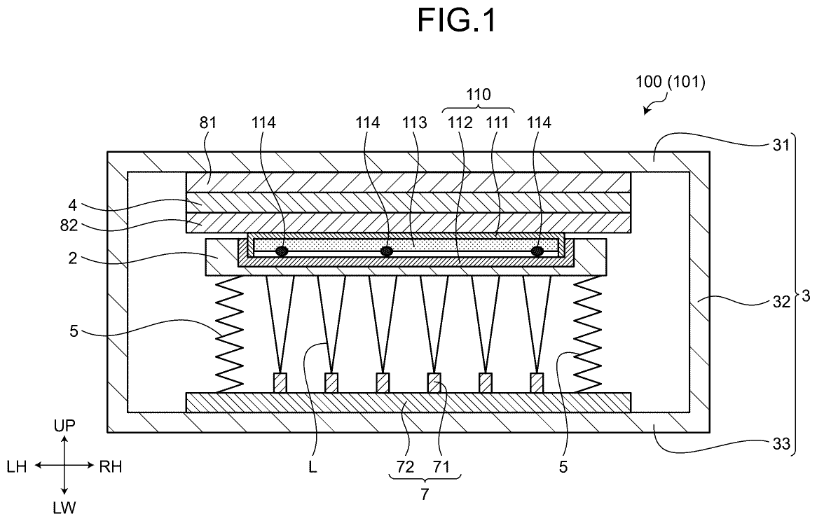

An embodiment of the present disclosure will first be described. FIG. 1 is a sectional view schematically illustrating an image acquisition device according to the embodiment.

As illustrated in FIG. 1, an image acquisition device 100 (detection device 101) includes a housing 3, a light source 7, a holding member 2, a view angle control film 82, an optical sensor 81, a light-transmitting adhesive layer 4, and springs (elastic members) 5. The holding member 2 holds a container 110.

The housing 3 includes a top panel 31, a side panel 32, and a bottom panel 33. A space surrounded by the top panel 31, the side panel 32, and the bottom panel 33 accommodates the light source 7, the holding member 2, the view angle control film 82, the optical sensor 81, the light-transmitting adhesive layer 4, the springs (elastic members) 5, and so forth.

The light source 7 includes a light source board 72 and a plurality of light-emitting elements 71. The light-emitting elements 71 are configured as light-emitting diodes (LEDs), for example. The light-emitting elements 71 emit light L. The light L emitted from the light-emitting elements 71 passes through the container 110 and is irradiated toward the optical sensor 81.

The holding member 2 is positioned above the light source 7. The holding member 2 holds the container 110. The container 110 has a light-transmitting property. A portion of the holding member 2 that overlaps the container 110 when viewed at least in the upper-lower direction has a light-transmitting property.

The view angle control film 82 limits the angle of incidence of the light L entering the optical sensor 81 in order to capture a clear image with the optical sensor 81. That is, of the light L emitted from the light-emitting elements 71, light that passes through the view angle control film 82 is a component thereof traveling in a direction orthogonal to the optical sensor 81. The view angle control film 82 is positioned on the upper side of the container 110 and on the lower side of the optical sensor 81. The view angle control film 82 is formed of a resin such as silicone rubber or polycarbonate, for example. The structure of the view angle control film 82 will be described later in detail.

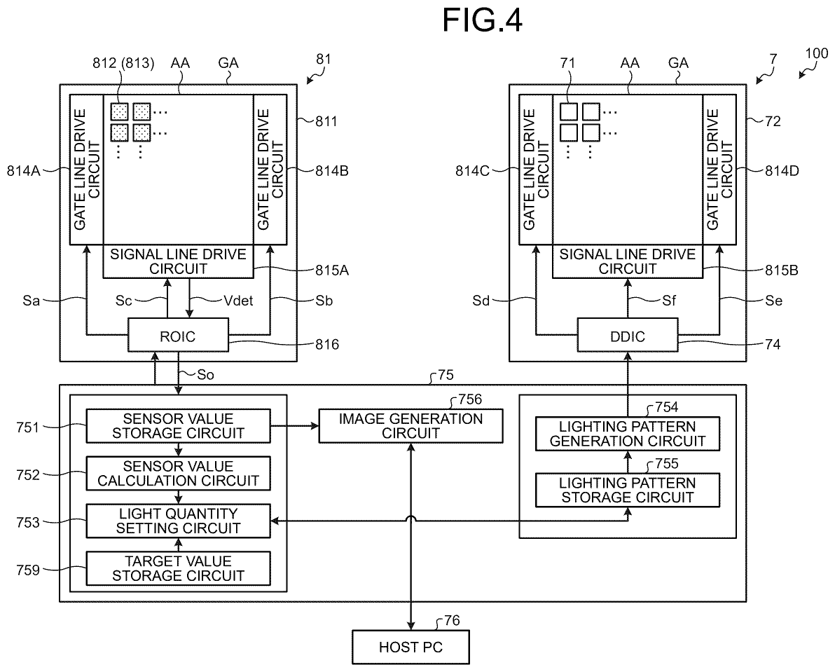

The optical sensor 81 is a planar detection device that includes a plurality of photodiodes 813 (photodetection elements, refer to FIG. 4) arranged in a planar configuration. The optical sensor 81 is positioned above the view angle control film 82. The light L that has passed through the view angle control film 82 is light traveling in the direction orthogonal to the optical sensor 81, and the orthogonal light is irradiated toward the photodiodes 813. The quantity of the light emitted to the photodiodes 813 of the optical sensor 81 differs between an area overlapping objects to be detected 114 and an area not overlapping the objects to be detected 114. As a result, the optical sensor 81 can image the objects to be detected 114.

The light-transmitting adhesive layer 4 bonds the view angle control film 82 to the optical sensor 81. In detail, the light-transmitting adhesive layer 4 bonds the entire surface of the view angle control film 82 to the entire surface of the optical sensor 81. In other words, the entire upper surface of the view angle control film 82 is bonded to the lower surface of the light-transmitting adhesive layer 4, and the entire lower surface of the optical sensor 81 is bonded to the upper surface of the light-transmitting adhesive layer 4. The light-transmitting adhesive layer 4 is positioned between the view angle control film 82 and the optical sensor 81. In other words, a predetermined gap is provided between the optical sensor 81 and the view angle control film 82 in the upper-lower direction, and the predetermined gap is filled with the light-transmitting adhesive layer 4. The light-transmitting adhesive layer 4 is larger than the container 110, for example, when viewed from above. That is, when viewed from the above, the edge of the light-transmitting adhesive layer 4 is positioned outside the edge of the container 110. The thickness of the light-transmitting adhesive layer 4 is, for example, 10 μm to 500 μm. The refractive index of the light-transmitting adhesive layer 4 has, for example, a value between the refractive index of the optical sensor 81 and the refractive index of the view angle control film 82. The refractive index of the light-transmitting adhesive layer 4 is, for example, 1.4 to 1.58.

The springs (elastic members) 5 push up and urge the holding member 2 upward. Since the container 110 is held by the holding member 2, the springs 5 push up and urge the holding member 2 and the container 110 upward. The springs 5 are positioned between the light source board 72 and the holding member 2. The springs 5 may be positioned between the bottom panel 33 of the housing 3 and the holding member 2.

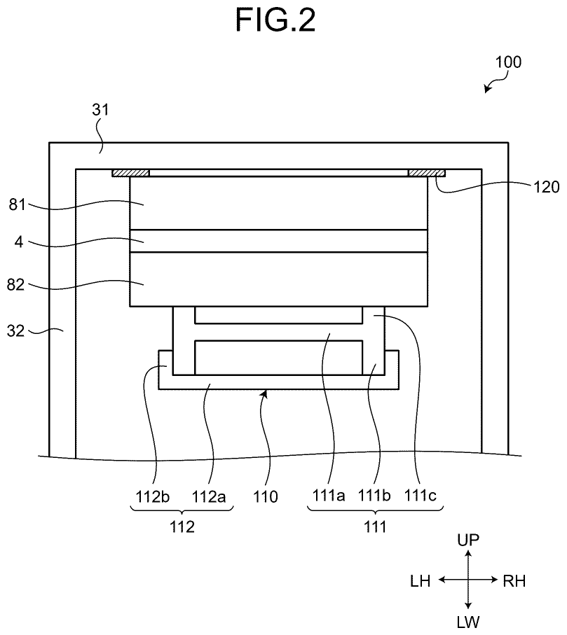

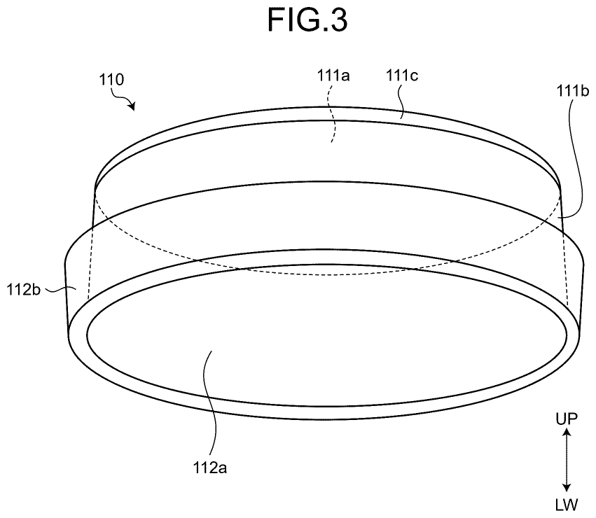

FIG. 2 is an enlarged schematic view of a part of FIG. 1. FIG. 3 is an enlarged perspective view of the container in FIG. 1. As illustrated in FIGS. 2 and 3, the container 110 is a light-transmitting Petri dish, for example.

The container 110 includes a container body 111 and a cover member 112. The container body 111 has a bottom portion 111a, a side portion 111b, and a projecting portion 111c. The bottom portion 111a is a disc-shaped member. The side portion 111b has a shape of a cylinder extending from the outer peripheral edge of the bottom portion 111a in a direction orthogonal to the bottom portion 111a. The projecting portion 111c has a shape of a cylinder extending from the outer peripheral edge of the bottom portion 111a toward the opposite side to the side portion 111b in the direction orthogonal to the bottom portion 111a. As illustrated in FIG. 1, the container body 111 accommodates a culture medium 113, and the objects to be detected 114 are applied onto a surface of the culture medium 113. The objects to be detected 114 are, for example, microorganisms such as bacteria, or a sample containing the microorganism, which form colonies on the culture medium 113 over time.

The cover member 112 is a lid that covers the opening of the container body 111. The cover member 112 has a top surface portion 112a and a side surface portion 112b. The top surface portion 112a is a disc-shaped member, and the side surface portion 112b has a shape of a cylinder extending from the outer peripheral edge of the top surface portion 112a in a direction orthogonal to the top surface portion 112a.

As described above, since the springs 5 push up and urge the holding member 2 and the container 110 upward, the container 110 is pressed against the lower surface of the view angle control film 82. In detail, the projecting portion 111c of the container 110 is pressed against the lower surface of the view angle control film 82. The projecting portion 111c overlaps the light-transmitting adhesive layer 4 when viewed from above.

In the present embodiment, the container 110 is placed upside down with respect to a normal container (Petri dish). That is, in the normal container, the container body is positioned on the lower side and the cover member is positioned on the upper side. By contrast, in the container 110 according to the present embodiment, the container body 111 is positioned on the upper side and the cover member 112 is positioned on the lower side.

In an orientation of the normal container, water vapor is generated from the culture medium 113, and the water vapor may adhere to the cover member as beads of water. In this case, the beads of water intervenes between the optical sensor 81 and the objects to be detected 114 and the culture medium 113 subject to monitoring, and these beads of water become noise or lenses, which may adversely affect image acquisition by the optical sensor 81. By contrast, in the container 110 according to the present embodiment, the cover member 112 is positioned on the lower side and the culture medium 113 is positioned on the upper side, so that, when the water vapor is generated from the culture medium 113, the water vapor is absorbed again into the culture medium 113. This reduces the beads of water adhering to the cover member, thereby reducing the adverse effect of the beads of water on the image acquisition.

FIG. 4 is a block diagram illustrating a configuration example of the image acquisition device according to the embodiment. As illustrated in FIG. 4, the image acquisition device 100 includes a host integrated circuit (IC) 75 that controls the optical sensor 81 and the light source 7. The optical sensor 81 includes an array substrate 811, a plurality of sensor pixels 812 (photodiodes 813) formed on the array substrate 811, gate line drive circuits 814A and 814B, a signal line drive circuit 815A, and a detection control circuit 816. The array substrate 811 is a glass substrate. The detection control circuit 816 is also referred to as a readout integrated circuit (ROIC).

Each of the sensor pixels 812 is configured with the photodiode 813, a plurality of transistors, and various types of wiring.

The array substrate 811 has a detection area AA and a peripheral area GA. The detection area AA is an area provided with the sensor pixels 812 (photodiodes 813). The peripheral area GA is an area between the outer perimeter of the detection area AA and the outer edges of the array substrate 811, and is an area not provided with the sensor pixels 812. The gate line drive circuits 814A and 814B, the signal line drive circuit 815A, and the detection control circuit 816 are provided in the peripheral area GA.

Each of the sensor pixels 812 is an optical sensor that includes the photodiode 813 as a sensor element. Each of the photodiodes 813 outputs an electrical signal corresponding to light emitted thereto.

The detection control circuit 816 is a circuit that supplies control signals Sa, Sb, and Sc to the gate line drive circuits 814A and 814B, and the signal line drive circuit 815A, respectively, to control operations of these circuits. The detection control circuit 816 includes a signal processing circuit that processes detection signals Vdet from the photodiodes 813.

The detection control circuit 816 processes the detection signals Vdet from the photodiodes 813, and outputs sensor values So based on the detection signals Vdet to the host IC 75. Through this operation, the image acquisition device 100 detects information on the objects to be detected 114.

The light source 7 includes the light source board 72, the light-emitting elements 71 formed on the light source board 72, gate line drive circuits 814C and 814D, a signal line drive circuit 815B, and a light-emitting element control circuit (DDIC) 74.

The light-emitting elements 71 are arranged in a matrix having a row-column configuration in an area of the light source board 72 overlapping the detection area AA. The light source board 72 is a drive circuit board that drives each of the light-emitting elements 71 so as to switch the state of the light-emitting element between on (lit state) and off (unlit state).

The light-emitting element control circuit 74 supplies control signals Sd, Se, and Sf to the gate line drive circuits 814C and 814D, and the signal line drive circuit 815B, respectively, to control operations of these circuits.

The host IC 75 includes, as a control circuit for the optical sensor 81, a sensor value storage circuit 751, a sensor value calculation circuit 752, a light quantity setting circuit 753, and a target value storage circuit 759. The sensor value storage circuit 751 stores therein the sensor values So output from the detection control circuit 816 of the optical sensor 81. The sensor value calculation circuit 752 performs a predetermined calculation process on the sensor values So of the photodiodes 813.

In a light quantity setting mode, the light quantity setting circuit 753 compares the sensor values So detected by the photodiodes 813 with a preset target sensor value So-t acquired from the target value storage circuit 759 to set light quantities of the light-emitting elements 71 for detection. The target value storage circuit 759 stores therein the preset target sensor value So-t.

The host IC 75 includes, as a control circuit for the light source 7, a lighting pattern generation circuit 754 and a lighting pattern storage circuit 755. The lighting pattern storage circuit 755 stores therein information on the light quantity of each of the light-emitting elements 71 in the light quantity setting mode.

The lighting pattern generation circuit 754 generates various control signals based on the information on the light quantity in the lighting pattern storage circuit 755.

The host IC 75 further includes an image generation circuit 756. In a detection mode, the image generation circuit 756 generates an image of the objects to be detected 114, based on the sensor values So output from the photodiodes 813. The image generation circuit 756 is coupled to an external host computer (PC) 76. The host PC 76 stores therein the image transmitted from the image generation circuit 756.

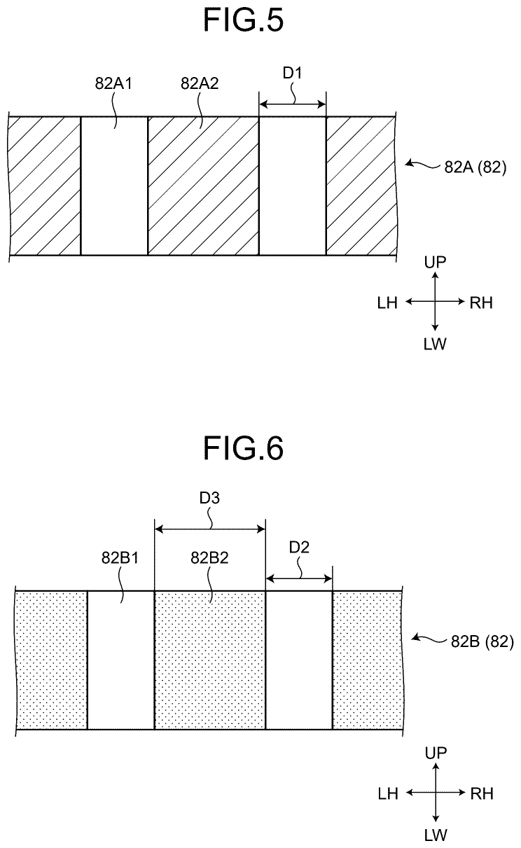

The following describes a configuration of the view angle control film 82. FIG. 5 is a sectional view schematically illustrating a collimator layer according to the embodiment. FIG. 6 is a sectional view schematically illustrating a louver layer according to the embodiment. A collimator layer 82A and a louver layer 82B have a function to transmit, toward the optical sensor 81, a component of the light L emitted from the light source 7 that travels in the upper-lower direction.

As illustrated in FIG. 5, the view angle control film 82 has a configuration in which, for example, a plurality of light-guide portions (holes) 82A1 are provided in a light-blocking portion 82A2. In other words, for example, cylindrical holes that penetrate the light-blocking portion 82A2 in the upper-lower direction are formed in the view angle control film 82, and the holes serve as the light-guide portions 82A1. Such a configuration is also referred to as the collimator layer 82A. The light-blocking portion 82A2 have higher optical absorbance than the light-guide portions (holes) 82A1. The light-guide portions (holes) 82A1 have a diameter D1, for example.

As illustrated in FIG. 6, the view angle control film 82 has, for example, a configuration in which light-blocking portions 82B2 and light-guide portions 82B1 are alternately arranged along the left-right direction. Such a configuration is also referred to as the louver layer 82B. The light-blocking portions 82B2 have higher optical absorbance than the light-guide portions 82B1. The thickness of light-guide portions 82B1 in the left-right direction is, for example, a thickness D2, and the thickness of the light-blocking portions 82B2 in the left-right direction is, for example, a thickness D3.

### Comparative Examples

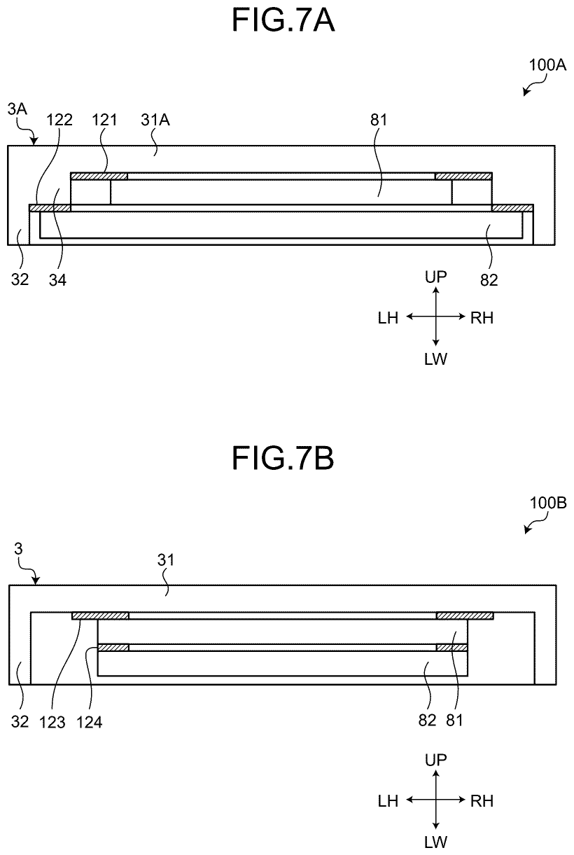

The following describes comparative examples of the present disclosure. FIG. 7A is a schematic view illustrating a state of mounting of the view angle control film and the optical sensor in a housing according to a first comparative example. FIG. 7B is a schematic view illustrating a state of mounting of the view angle control film and the optical sensor in the housing according to a second comparative example.

As illustrated in FIG. 7A, an image acquisition device 100A according to the first comparative example includes a housing 3A. The housing 3A has a projection 34 at a corner formed by a top panel 31A and the side panel 32. That is, in the section of FIG. 7A, the projection 34 projecting downward is provided at the corner where the top panel 31A extending in the left-right direction intersects the side panel 32 extending in the upper-lower direction. The projections 34 are provided at both the left and right ends of the top panel 31A. The projection 34 has a rectangular shape. The optical sensor 81 is bonded to the lower surface of the top panel 31A with double-sided tape 121 interposed therebetween. In detail, in the section of FIG. 7A, each of both ends in the left-right direction of the optical sensor 81 is bonded to the lower surface of the top panel 31A with the double-sided tape 121 interposed therebetween. The view angle control film 82 is bonded to the lower surfaces of the projections 34 with a double-sided tape 122 interposed therebetween. In detail, in the section of FIG. 7A, both ends in the left-right direction of the view angle control film 82 are bonded to the lower surfaces of the two projections 34, respectively, with the double-sided tape 121 interposed therebetween. The view angle control film 82 and the optical sensor 81 are arranged with a slight gap interposed therebetween in the upper-lower direction. The gap between the view angle control film 82 and the optical sensor 81 is, for example, 50 μm to 600 μm.

As illustrated in FIG. 7B, an image acquisition device 100B according to the second comparative example includes the housing 3. The housing 3 includes the top panel 31 and the side panel 32. The optical sensor 81 is bonded to the lower surface of the top panel 31 with double-sided tape 123 interposed therebetween. In detail, in the section of FIG. 7B, each of both ends in the left-right direction of the optical sensor 81 is bonded to the lower surface of the top panel 31 with the double-sided tape 123 interposed therebetween. The view angle control film 82 is bonded to the lower surface of the optical sensor 81 with double-sided tape 124 interposed therebetween. In detail, in the section of FIG. 7B, both ends in the left-right direction of the view angle control film 82 are bonded to both ends in the left-right direction on the lower surface of the optical sensor 81, respectively, with the double-sided tape 124 interposed therebetween. The gap between the view angle control film 82 and the optical sensor 81 is, for example, 50 μm to 600 μm.

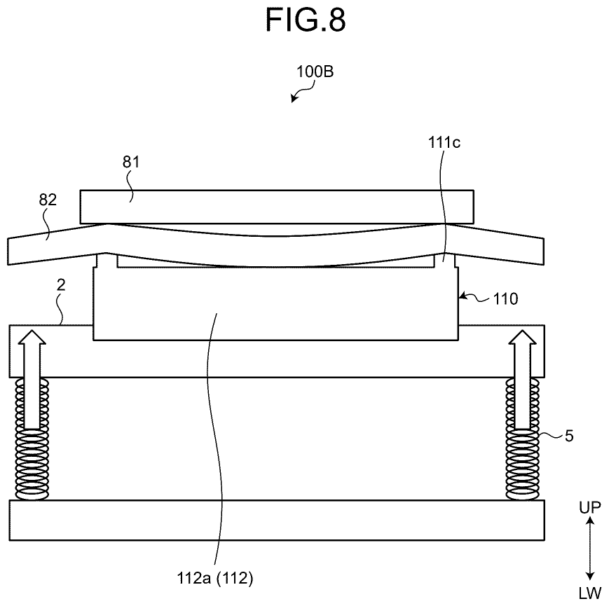

FIG. 8 is a schematic view of the image acquisition device according to a comparative example. FIG. 8 illustrates an aspect of the image acquisition device 100B in which a gap is provided between the view angle control film 82 and the optical sensor 81, as illustrated in FIGS. 7A and 7B.

The image acquisition device 100B according to the comparative example differs from the image acquisition device 100 of the embodiment illustrated in FIGS. 1 and 2 in that a gap is provided between the view angle control film 82 and the optical sensor 81. A detailed description will be made below.

In the image acquisition device 100 of the embodiment illustrated in FIGS. 1 and 2, the view angle control film 82 is bonded to the optical sensor 81 with the light-transmitting adhesive layer 4 interposed therebetween. Therefore, no gap is provided between the view angle control film 82 and the light-transmitting adhesive layer 4, and no gap is provided between the optical sensor 81 and the light-transmitting adhesive layer 4.

By contrast, in the image acquisition device 100B illustrated in FIG. 8, a gap in the upper-lower direction is provided between the view angle control film 82 and the optical sensor 81, as described with reference to FIG. 7B. That is, when viewed from above, the peripheral edge of the view angle control film 82 is bonded to the peripheral edge of the optical sensor 81 with the double-sided tape 124, but inside the double-sided tape 124, the view angle control film 82 is not bonded to the optical sensor 81.

When, in this state, the springs 5 push up and urge the holding member 2 and the container 110 upward, the projecting portion 111c of the container 110 is pressed against the view angle control film 82. Since the gap in the upper-lower direction is provided between the view angle control film 82 and the optical sensor 81, a portion of the view angle control film 82 pressed against the projecting portion 111c recedes upward. As a result, distortion in the upper-lower direction is formed in the view angle control film 82, as illustrated in FIG. 8.

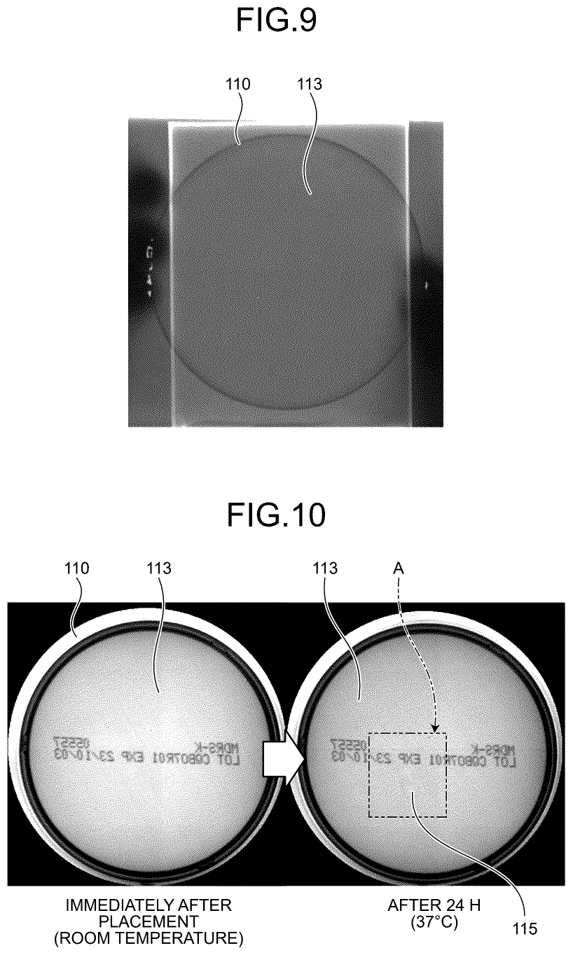

FIG. 9 is a photographic image of the culture medium captured by the image acquisition device of the embodiment. FIG. 10 illustrates photographic images of the culture medium captured by the image acquisition device of the second comparative example illustrated in FIG. 7B. In FIG. 10, an initial photographic image of the container 110 accommodating the culture medium 113 (temperature is room temperature) is illustrated on the left side, and a photographic image of the culture medium 113 (temperature is 37° C.) after 24 hours are elapsed is illustrated on the right side.

As illustrated in FIG. 9, the photographic image of the culture medium captured by the image acquisition device 100 of the embodiment does not include interference fringes. However, the photographic image on the right side in FIG. 10 includes interference fringes 115 in an area A surrounded by a long dashed double-short dashed line.

As described above, the image acquisition device 100 according to the embodiment includes the light source 7, the holding member 2 positioned above the light source 7 and configured to hold the container 110, the view angle control film 82 positioned on the upper side of the container 110, the planar optical sensor 81 positioned above the view angle control film 82, the light-transmitting adhesive layer 4 between the view angle control film 82 and the optical sensor 81 and configured to bond the view angle control film 82 to the optical sensor 81, and the springs (elastic members) 5 configured to push up and urge the holding member 2 upward to press the container 110 against the view angle control film 82.

When the springs 5 push up the holding member 2 to press the container 110 against the view angle control film 82, if a gap is present between the view angle control film 82 and the optical sensor 81 as in the first and the second comparative examples illustrated in FIGS. 7A and 7B, the view angle control film 82 and the optical sensor 81 are distorted as illustrated in FIG. 8, whereby the interference fringes 115 illustrated in FIG. 10 is more likely to occur. In particular, when the objects to be detected 114 are microorganisms such as bacteria, or a sample containing the microorganism that form colonies on the culture medium 113 over time, the image acquisition device 100 is positioned under an environment in which temperature is higher than room temperature. Thus, when the container 110 is under the high temperature environment and pressed against the view angle control film 82, the distortion of the view angle control film 82 and the optical sensor 81 becomes greater, which may reduce the detection accuracy of the optical sensor.

By contrast, in the present embodiment, the light-transmitting adhesive layer 4 is positioned between the view angle control film 82 and the optical sensor 81, and the light-transmitting adhesive layer 4 bonds the view angle control film 82 to the optical sensor 81. Therefore, gaps are less likely to occur between the view angle control film 82 and the light-transmitting adhesive layer 4, and also between the optical sensor 81 and the light-transmitting adhesive layer 4. Consequently, in the present embodiment, even under the high temperature environment and when the container 110 is pressed against the view angle control film 82, the distortion of the view angle control film 82 and the optical sensor 81 is less likely to occur, and thus the interference fringes do not occur as illustrated in FIG. 9, resulting in higher detection accuracy at the optical sensor 81.

The predetermined gap is provided between the optical sensor 81 and the view angle control film 82, and the predetermined gap is filled with the light-transmitting adhesive layer 4.

As described above, in the first and the second comparative examples illustrated in FIGS. 7A and 7B, if a gap is present between the view angle control film 82 and the optical sensor 81, the interference fringes 115 are likely to be produced, which may reduce the detection accuracy at the optical sensor 81.

By contrast, since the predetermined gap is filled with the light-transmitting adhesive layer 4 in the present embodiment, the distortion of the view angle control film 82 and the optical sensor 81 is less likely to occur even under the high temperature environment and when the container 110 is pressed against the view angle control film 82, resulting in higher detection accuracy at the optical sensor 81, in the present embodiment.

The container is a Petri dish. The Petri dish has the projecting portion 111c projecting toward the view angle control film and pressed against the view angle control film 82. When viewed from above, the light-transmitting adhesive layer 4 overlaps the projecting portion 111c.

A portion of the view angle control film 82 pressed against the projecting portion 111c of the Petri dish is locally loaded with a larger force, resulting in greater distortion of the view angle control film 82. However, the light-transmitting adhesive layer 4 overlaps the projecting portion 111c when viewed from above, so that the distortion of the view angle control film 82 and optical sensor 81 is dispersed to be smaller, resulting in higher detection accuracy at the optical sensor 81.

The optical sensor 81 includes a glass substrate (array substrate 811). Making the refractive index of the glass substrate (array substrate 811) closer to the refractive index of the light-transmitting adhesive layer 4 can reduce blur of the captured image and further restrain the image quality from deteriorating.

The refractive index of the light-transmitting adhesive layer 4 has a value between the refractive index of the optical sensor 81 and the refractive index of the view angle control film 82.

Fresnel reflection refer to reflection of part of light incident on a boundary surface where materials having different refractive indices are in contact with each other. Therefore, by setting the refractive index of the light-transmitting adhesive layer 4 to a value between that of the optical sensor 81 and that of the view angle control film 82, the Fresnel reflection can be reduced and a larger quantity of light can be received by the optical sensor 81.

The refractive index of the light-transmitting adhesive layer 4 is 1.4 to 1.58. This range of the refractive index reduces the Fresnel reflection and increases the quantity of light that is received by the optical sensor 81.

The thickness of the light-transmitting adhesive layer 4 is 10 μm to 500 μm.

Since a larger distance between the objects to be detected 114 and the optical sensor 81 may result in a blurred and unclear captured image, the thickness of the light-transmitting adhesive layer 4 is preferably smaller. However, if the thickness of the light-transmitting adhesive layer 4 is too small, the adhesive strength between the view angle control film 82 and the light-transmitting adhesive layer 4 may decrease. Therefore, to reduce the distance between the objects to be detected 114 and the optical sensor 81 and maintain the adhesive strength between the view angle control film 82 and the light-transmitting adhesive layer 4, the thickness of the light-transmitting adhesive layer 4 is preferably 10 μm to 500 μm.

The optical sensor 81 includes the photodiodes 813. The photodiodes have advantages of relatively higher linearity of output current with respect to the quantity of incident light and higher speed of response.

The view angle control film 82 may have the configuration in which the light-guide portions 82B1 and the light-blocking portions 82B2 are alternately arranged, or the configuration in which the light-guide portions 82A1 are provided in the light-blocking portion 82A2. Since either one of these configurations allows the view angle control film 82 to block light in oblique directions, the blur of the image captured by the photodiodes 813 can be reduced.

What is claimed is:

1. An image acquisition device comprising, in sequence:
a light source;
a holding member configured to hold a container accommodating an object to be detected;
a view angle control film; and
a planar optical sensor,
and further comprising:
a light-transmitting adhesive layer between the view angle control film and the optical sensor and configured to bond the view angle control film to the optical sensor; and
an elastic member configured to push up and urge the holding member upward to press the container against the view angle control film.

2. The image acquisition device according to claim 1, wherein a predetermined gap is provided between the optical sensor and the view angle control film, and the gap is filled with the light-transmitting adhesive layer.

3. The image acquisition device according to claim 1, wherein
the container is a Petri dish,
the Petri dish has a projecting portion projecting toward the view angle control film and pressed against the view angle control film, and
the light-transmitting adhesive layer overlaps the projecting portion, when viewed from above.

4. The image acquisition device according to claim 3, wherein the optical sensor comprises a glass substrate.

5. The image acquisition device according to claim 3, wherein a refractive index of the light-transmitting adhesive layer has a value between the refractive index of the optical sensor and the refractive index of the view angle control film.

6. The image acquisition device according to claim 5, wherein the refractive index of the light-transmitting adhesive layer is 1.4 to 1.58.

7. The image acquisition device according to claim 5, wherein the light-transmitting adhesive layer has a thickness of 10 μm to 500 μm.

8. The image acquisition device according to claim 4, wherein the optical sensor comprises a plurality of photodiodes.

9. The image acquisition device according to claim 3, wherein a plurality of light-guide portions and a plurality of light-blocking portions are alternately arranged in the view angle control film.

10. The image acquisition device according to claim 3, wherein a plurality of light-guide portions are provided in a light-blocking portion of the view angle control film.
